(19) United States
(12) Patent Application Publication
(10) Pub. No.: US 2025/0164120 A1
(43) Pub. Date: May 22, 2025

(54) HYBRID WATER HEATER SYSTEM

(71) Applicant: Apparent Labs, LLC, Novato, CA (US)

(72) Inventor: Stefan MATAN, Novato, CA (US)

(21) Appl. No.: 18/841,046

(22) PCT Filed: Feb. 28, 2023
(86) PCT No.: PCT/US2023/014192

§ 371 Date: Aug. 23, 2024

Related U.S. Application Data
(60) Provisional application No. 63/315,078, filed on Feb. 28, 2022.

(51) Int. Cl. F24D 17/00; F24D 19/10; F24H 1/20; F24H 15/223; F24H 15/355; H02J 3/28; H02J 3/38; H02S 50/00

(52) U.S. Cl. CPC F24D 17/0036; F24D 19/1057; F24H 15/223; F24H 15/355; H02J 3/28; H02J 3/38; H02S 50/00; F24H 1/202; F24H 2250/02; H02J 2300/26; H02J 2310/14

(57) ABSTRACT

A system powers a resistive load with switched direct current (DC) power. The high-speed switching of the resistive load heats up the resistive load with a pseudo-DC current. The resistive load can be a water heater element. The water heater can also have another heating element, which allows the pseudo-DC signal to pre-heat the water heater with local solar power, reducing the need for outside energy to power the other heating element.

### PRIORITY

This application is based on, and claims the benefit of priority to, U.S. Provisional Application No. 63/315,078, filed Feb. 28, 2022.

### TECHNICAL FIELD

Descriptions are generally related to heating elements, and more particular descriptions are related to powering a direct current (DC) heating element with a switched DC signal.

### BACKGROUND OF THE INVENTION

Electrical heating elements, especially the kind used in water heater systems, consist of resistive elements that heat up in response to current running through the heating element. The need for electrical power to charge heating elements provides additional load on the power grid.

In the drive to take load off the power grid, many consumers are becoming prosumers, producing energy locally with renewable resources. Local energy sources systems are typically direct current (DC) sources, such as solar systems. Converting DC power to alternating current (AC) power to heat up the element tends to be an inefficient use of energy.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that charges a heating element with a switched DC source.

FIG. 2 is a diagrammatic representation of an example of changing maximum power point tracking behavior based on a change of impedance in the load.

FIG. 3 is a block diagram of an example of a hybrid water heating system with a grid electrical heating element.

FIG. 4 is a block diagram of an example of a hybrid water heating system with a gas heating element.

FIG. 5A is a block diagram of an example of a controller for a system that charges a heating element with a switched DC source.

FIG. 5B is a block diagram of an example of a hybrid water heating system that selects between DC sources.

FIG. 6A-6B are circuit representations of examples of a system that switches a DC source.

FIG. 7 is a flow diagram of an example of powering a heating element.

Descriptions of certain details and implementations follow, including non-limiting descriptions of the figures, which may depict some or all examples, and well as other potential implementations.

### DETAILED DESCRIPTION OF THE INVENTION

As described herein, a system powers a resistive load with switched direct current (DC) power. The high-speed switching of the resistive load heats up the resistive load with a pseudo-DC current. The switching can occur at approximately 10 kHz (kilohertz). Alternatively, the controller can switch the DC power at a frequency greater than 10 kHz, in the range of tens of kilohertz. To a DC system, the high-speed/high-frequency switching appears to be a DC signal, seeing that the system does not react to the fluctuations in voltage since they happen fast enough that the drop in voltage does not significantly alter the performance of the load components.

The resistive load can be a water heater element. The water heater can also have another heating element, which allows the pseudo-DC signal to pre-heat the water heater with local solar power, reducing the need for outside energy to power the other heating element. The electrical heating element can be supplied power from a photovoltaic (PV) source, or a battery, or from both a PV source and a battery. The additional heating element can be an electrical heating element that is charged by grid electrical power. The additional heating element can be a gas heating element.

In one example, the PV heating element is physically positioned in the water heater container to cause it to be used before the additional heating element. For example, the PV heating element can be located near a bottom of the water tank, with the other heating element near a top of the tank. As such, the second heating element may only kick on to the extent that the PV heating element does not heat the tank to the desired temperature. In one example, the PV heating element is located closer to the thermostat than the other heating element.

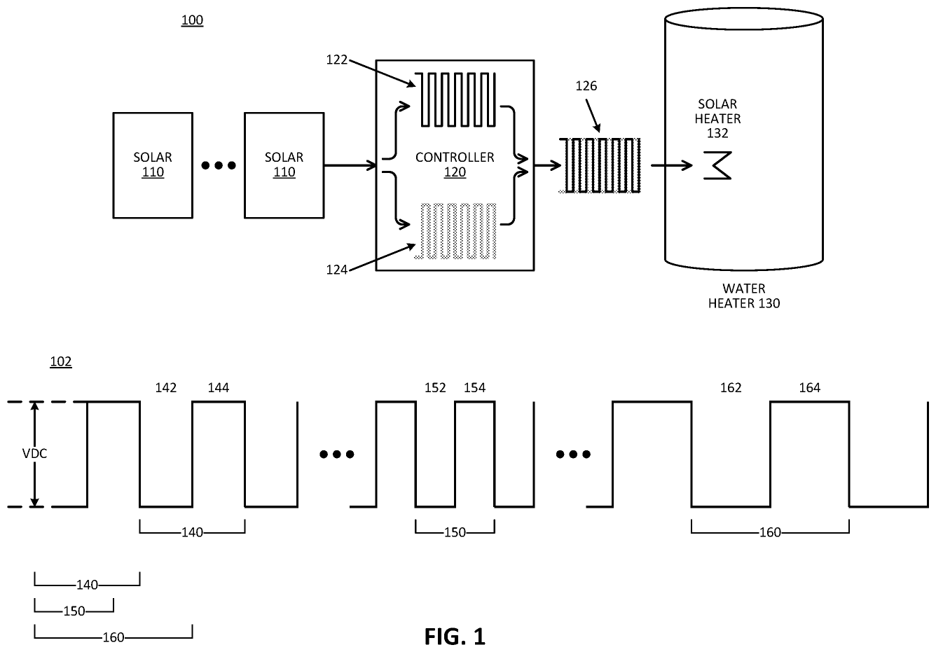

FIG. 1 is a block diagram of an example of a system that charges a heating element with a switched DC source. System 100 represents an application of a resistive load that changes resistance as the temperature changes. The application in system 100 is a water heating element.

System 100 includes water heater 130 with solar heater 132. In one example, solar heater 132 represents a resistive element (e.g., an element having a 1 Ohm (Q) resistance). In one example, solar heater 132 is made up of a material that heats up in response to a constant fluctuation of electrons and not to a direct current. Thus, applying a straight DC signal to solar heater 132 would have little to no heating effect. Conversely, switching the DC signal at a high speed can cause constant electron fluctuations in the material, causing it to heat up. Thus, solar heater 132 represents a heating element having a material that heats up in response to a high frequency signal and not to a constant voltage signal.

In one example, water heater 130 represents a hybrid water heater that has solar heater 132 and can also be heated either electrically from a grid connection or heated with a gas heater. In one example, rather than switching the DC signal into an AC signal (e.g., nominally 120 V or 240 V at 50-60 Hz), the DC signal can be a low-voltage switched DC signal. The low-voltage DC signal refers to a signal that is significantly lower than the 120/240 V of the grid, such as the 48 V of a solar panel array. In contrast to the 50-60 Hz frequency of the high-voltage signal, the low-voltage DC signal (which could alternatively be referred to as a pseudo-DC signal) can be switched at approximately 10 kHz or higher.

By using a lower voltage, solar heater 132 would not be subject to the restrictions and regulations as the signals at grid voltage. Additionally, rather than converting the energy into AC, the energy can be applied in a pseudo-DC manner, resulting in higher efficiency heating.

System 100 illustrates solar cells 110, which represent parallel solar panels that provide solar energy used to heat solar heater 132. System 100 includes controller 120 to convert the energy from solar cells 110 to a switched DC signal to charge solar heater 132. In one example, controller 120 can use two transistors in parallel on complementary gates to generate two signals switched at high frequency. Controller 120 can generate the two signals without the need for transformers used in traditional switched power sources. The high speed switching to control the solar output can allow the energy to be dispatchable by controlling how the energy is applied to the circuit that receives it. The two complementary signals can be combined into a single signal output by controller 120 to power solar heater 132.

System 100 represents switched signal 122 and complementary switched signal 124 in controller 120. It will be understood that the signals shown in controller 120 do not necessarily mean that the power flows through the controller, but that the controller shapes the power or energy available in the illustrated signals. System 100 can include other circuit elements not specifically illustrated, which will shape the energy signals to heat the water heater. Signal 126 represents the switched and shaped signal applied to charge solar heater 132.

In one example, controller 120 can change the switching of the signals based on a change in temperature in water heater 130. A change in temperature of water heater 130 will cause the material of solar heater 132 to be increased in temperature, which can change the impedance of the solar heater element. In one example, controller 120 changes the switching by adjusting the frequency of the switched DC signal, which has the effect of changing the impedance matching of the input signal.

Diagram 102 represents a sequence of switching that controller 120 can provide to solar heater 132. The sequence of signals illustrates a constant DC voltage (VDC) with different frequency. As illustrated under the sequence of signals, the period of signal portion 140 is greater than the period of signal portion 150, and less than the period of signal portion 160.

Consider that signal portion 140 illustrates a period for a switched signal during heating with the heating element. Signal portion 140 includes off time 142 and on time 144 for the switched signal. Consider that the water is heated as the heating element heats up. As it heats up, its rho (p) increases. For simplicity, the description will refer to an increase in resistance, Q, with the increase in temperature. As the resistance/impedance changes, the energy transfer will degrade in efficiency due to the impedance mismatch. Controller 120 can change the frequency of the switched signal to improve the impedance match with the resistive load.

In one example, controller 120 includes table information (not specifically shown) to match a measured temperature with the material resistivity information. The table information can indicate a switching frequency to use when different temperatures are measured to enable impedance matching with the heating element. In one example, diagram 102 represents a switched current signal generated from the DC current from a DC energy source.

Thus, consider that signal portion 150 represents a response to the temperature rising, where an increased frequency will produce better impedance matching. Signal portion 150 includes off time 152 and on time 154 for the switched signal. Consider further that signal portion 160 represents a response to the temperature decreasing, where the low frequency will provide an improved impedance match to the heating element. Signal portion 160 includes off time 162 and on time 164 for the switched signal.

Signal portion 140, signal portion 150, and signal portion 160 are not necessarily drawn to scale. The signal portions only illustrate a primary signal without a complementary signal. It will be understood that the different frequencies available can depend on the system's ability to generate different frequencies, as well as the precision of the temperature measurement. The switching for impedance matching will be dependent on the material/properties of the resistive load connected to receive the switched signal.

In one example, heating system can include the heating element and the controller, which can together be considered a water heating system or a controller/controller system to heat liquid. Controller 120 does not specifically illustrate the power converter circuit that is/includes the switching circuit. Examples are provided below.

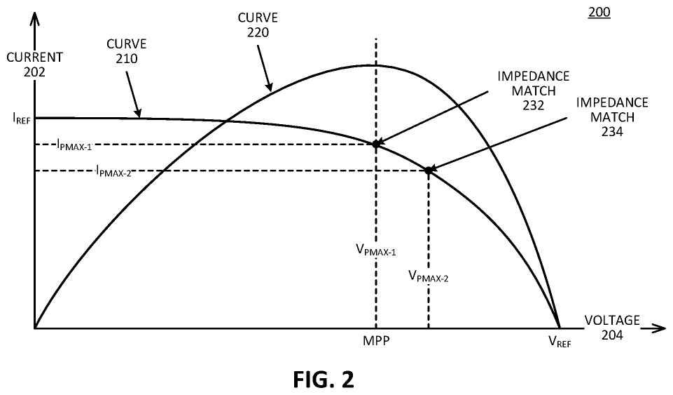

FIG. 2 is a diagrammatic representation of an example of changing maximum power point tracking behavior based on a change of impedance in the load. In one example, the controller of system 100 performs maximum power point tracking (MPPT) to convert the energy from the PV source to the switched DC signal.

Diagram 200 illustrates two curves, curve 210 and curve 220, plotted as current 202 versus voltage 204. Curve 210 represents a portion of the non-linear voltage-current (V-I) characteristic behavior of a solar cell/PV source. The V-I characteristic curve can alternatively be referred to as the power characteristic curve or power curve. Curve 220 represents a plot of the current times the voltage of curve 210. It will be understood that diagram 200 is not intended to show the entire V-I curve (e.g., the x-axis and y-axis may not start at ‘0’), but rather a portion near the “knee” of the power curve where the maximum power point (MPP) is found.

Diagram 200 illustrates a portion of the curves to highlight the differences discussed below. It will be understood that diagram 200 is not necessarily to scale, and different PV sources can have different characteristic curves. It will also be understood that the general shape of the curves can be generally representative of PV sources.

Typical power curves extend from the short circuit current (I_{SC}) on the y-axis to the open circuit voltage (V_{OC}) on the x-axis. To further illustrate that diagram 200 illustrates does not necessarily cover the entirety of curve 210, curve 210 extends from I_{REF} to V_{REF}, which are respective current and voltage points at the axes illustrated.

Diagram 200 illustrates I_{PMAX-1}, which intersects with V_{PMAX-1} on curve 210 at impedance match 232. I_{PMAX-1} represents a current for the MPP, which corresponds to V_{PMAX-1}. It will be observed that MPP intersects the apex of curve 220. It will be understood that the MPP tends to change based over time based on changing conditions, such as illumination level, panel temperature, panel age, cleanliness of the panel, and other conditions. As the conditions change, the knee of curve 210 will change, and the corresponding curve 220 will change.

MPPT algorithms track the MPP as it changes with changing conditions. However, it will be understood that MPPT algorithms expect to match a particular condition. Namely, MPPT tracks the MPP assuming a constant impedance to be matched. While the algorithms track for changes in the conditions of the panels, the output will not result in the highest efficiency energy transfer when the impedance to be matched does not match the expectations of the MPPT algorithm.

The controllers described herein can perform MPPT with adjustment for a change to the load impedance. When the resistive load is a heating element, the rho value changes with the temperature. In one example, the controllers/control circuits described herein provide control over the DC signal switching to match the MPP decision with the load impedance. Without adjusting for the change in impedance, the MPP would not be the MPP. Adjusting for the MPPT based on the solar characteristics as well as the distortion to the MPPT curve based on the change to resistance, the system provides a better impedance match.

Diagram 200 does not specifically illustrate “distortion” in the MPPT curve. Rather, diagram 200 illustrates impedance match 234, which represents a theoretical place on curve 210 that provides accurate impedance matching with the load. Thus, while impedance match 232 can represent impedance match 232 as an ideal impedance match based solely on the conditions and characteristics of the solar panel/solar array, impedance match 234 represents the ideal impedance match based on a change to resistance of the load based on a change in temperature of the load.

Thus, the intersection of I_{PMAX-2} with V_{PMAX-2} on curve 210 at impedance match 234 is presented to represent a change to the MPP based on the load conditions. I_{PMAX-2} represents a current for the preferred impedance match point, which corresponds to V_{PMAX-2}. In diagram 200, impedance match 234 would not correspond with the apex of curve 220, but would match up with a curve that is adjusted for the distortion based on the change in load impedance.

For purposes of a total system view, impedance match 234 can be considered the MPP for the power curve. The system can include an MPPT unit that tracks the MPP for the adjusted power curve as described above.

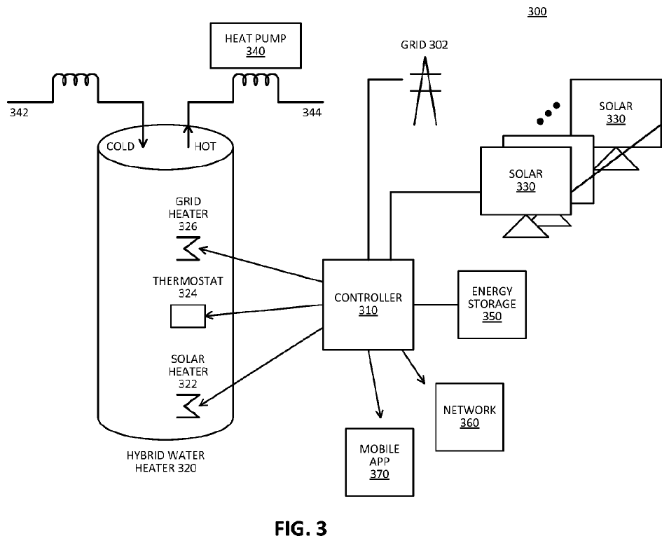

FIG. 3 is a block diagram of an example of a hybrid water heating system with a grid electrical heating element. System 300 represents a system in accordance with an example of system 100. System 300 includes hybrid water heater 320 that can be heated electrically from a grid connection, or electrically from solar energy. The solar energy can be low voltage (e.g., 48 V or the voltage of solar panels).

Hybrid water heater 320 includes a tank with solar heater 322 that can be located near a base on the tank or near thermostat 324. Solar heater 322 represents a resistive load that changes impedance with a change in temperature in accordance with any example herein. Thermostat 324 represents a thermostat, whether mechanical or digital, within the tank. A digital thermostat can have improved accuracy and provide better feedback to the controller to enable improved impedance matching with solar heater 322. Based on the temperature inside the tank, the temperature of the heating element can be inferred or calculated.

Grid heater 326 represents an electrical heating element to be powered by grid power, from a grid connection to grid 302. In one example, grid heater 326 is physically located near a top of the water heater tank, such as in the top half, where solar heater 322 can be in the bottom half. In one example, rather than specific halves of the tank, solar heater 322 can be located physically closer to thermostat 324 than grid heater 326.

System 300 includes controller 310, which can represent a gateway controller, which is a controller that manages the input of solar energy from multiple solar cells connected in parallel. Solar 330 represents a solar array, which can include multiple solar panels connected in parallel. Controller 310 can include or can control a converter circuit that generates switched pseudo-DC power (e.g., low voltage power) to provide to solar heater 322. With the power, solar heater 322 can heat up the liquid in hybrid water heater 320. Controller 310 can provide MPPT as described above.

In one example, controller 310 can alternatively provide the energy from solar 330 to an energy storage device (e.g., a battery). Energy storage 350 represents local energy storage at a consumer premises along with the local solar 330. For example, when hybrid water heater 320 is at a desired temperature, solar heater 322 would not need additional solar energy, which controller 310 can then provide to energy storage 350. At a later time, when solar 330 does not provide sufficient energy to charge solar heater 322, controller 310 can select energy storage 350 as the energy source to charge the heating element.

In one example, the gateway controller enables the operation of the solar power to be dispatchable or controllable from a remote management. Controller 310 can be in communication with mobile application (app) 370, which can control the operation of the heater remotely, such as controlling the temperature of hybrid water heater 320. Controller 310 can be in communication with network 360, such as the Internet. Network communication can enable controller 310 to receive command signals from a management source, such as a grid controller.

In one example, hybrid water heater 320 is an electric water heater, which can normally be heated from a grid connection, such as a 220 V connection through grid heater 326 based on power from grid 302. Solar heater 322 represents a heating element/heater that generates heating from solar 330 and/or energy storage 350, and operates at a lower voltage than grid heater 326.

Thermostat 324 represents a control element in the water heater, which provides feedback that additional heating is not required because a target temperature has been reached. In one example, hybrid water heater 320 first applies energy from solar 330, through solar heater 322 to heat the water heater, and only turns on grid heater 326 if a target temperature has not been reached. However, since the water can first be heated by the solar energy, less grid energy is needed to heat the water. If solar heater 322 does not need to operate while solar 330 is generating solar energy, controller 310 can direct the excess solar energy to charge energy storage 350.

In one example, cold water input line 342 and hot water output line 344 can be connected to one or more heat pumps to provide additional energy recovery. Heat pump 340 represents such a heat pump on hot water output line 344. A similar heat pump can be provided on cold water input line 342.

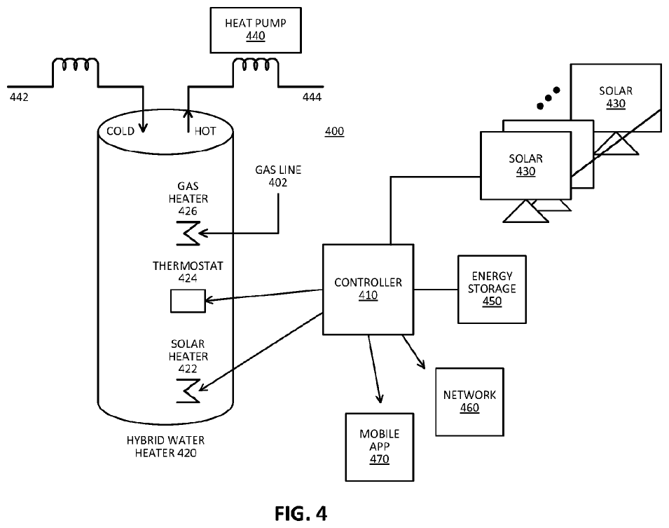

FIG. 4 is a block diagram of an example of a hybrid water heating system with a gas heating element. System 400 represents a system in accordance with an example of system 100. System 400 includes hybrid water heater 420 that can be heated by a gas connection or electrically from solar energy. The solar energy can be low voltage (e.g., 48 V or the voltage of solar panels).

Hybrid water heater 420 includes a tank with solar heater 422 that can be located near a base on the tank or near thermostat 424. Solar heater 422 represents a resistive load that changes impedance with a change in temperature in accordance with any example herein. Thermostat 424 represents a thermostat, whether mechanical or digital, within the tank. A digital thermostat can have improved accuracy and provide better feedback to the controller to enable improved impedance matching with solar heater 422.

Gas heater 426 represents a gas heating element to be powered by a gas connection to gas line 402. In one example, gas heater 426 is physically located near a top of the water heater tank, such as in the top half, where solar heater 422 can be in the bottom half. In one example, rather than specific halves of the tank, solar heater 422 can be located physically closer to thermostat 424 than gas heater 426.

System 400 includes controller 410, which can represent a gateway controller, which is a controller that manages the input of solar energy from multiple solar cells connected in parallel. Solar 430 represents a solar array, which can include multiple solar panels connected in parallel. Controller 410 can include or can control a converter circuit that generates switched pseudo-DC power (e.g., low voltage power) to provide to solar heater 422. With the power, solar heater 422 can heat up the liquid in hybrid water heater 420. Controller 410 can provide MPPT as described above.

In one example, controller 410 can alternatively provide the energy from solar 430 to an energy storage device (e.g., a battery). Energy storage 450 represents local energy storage at a consumer premises along with the local solar 430. For example, when hybrid water heater 420 is at a desired temperature, solar heater 422 would not need additional solar energy, which controller 410 can then provide to energy storage 450. At a later time, when solar 430 does not provide sufficient energy to charge solar heater 422, controller 410 can select energy storage 450 as the energy source to charge the heating element.

In one example, the gateway controller enables the operation of the solar power to be dispatchable or controllable from a remote management. Controller 410 can be in communication with mobile application (app) 470, which can control the operation of the heater remotely, such as controlling the temperature of hybrid water heater 420. Controller 410 can be in communication with network 460, such as the Internet. Network communication can enable controller 410 to receive command signals from a management source, such as a grid controller.

In one example, hybrid water heater 420 is a gas water heater, which can normally be heated from a gas source, such as natural gas through gas line 402. Gas heater 426 represents a heater that generates heating from a gas source. Solar heater 422 represents a heating element/heater that generates heating from solar 430 and/or energy storage 450, and operates at a low voltage.

Thermostat 424 represents a control element in the water heater, which provides feedback that additional heating is not required because a target temperature has been reached. In one example, hybrid water heater 420 first applies energy from solar 430, through solar heater 422 to heat the water heater, and only turns on gas heater 426 if a target temperature has not been reached. However, since the water can first be heated by the solar energy, less gas heating is needed to heat the water. If solar heater 422 does not need to operate while solar 430 is generating solar energy, controller 410 can direct the excess solar energy to charge energy storage 450.

In one example, cold water input line 442 and hot water output line 444 can be connected to one or more heat pumps to provide additional energy recovery. Heat pump 440 represents such a heat pump on hot water output line 444. A similar heat pump can be provided on cold water input line 442.

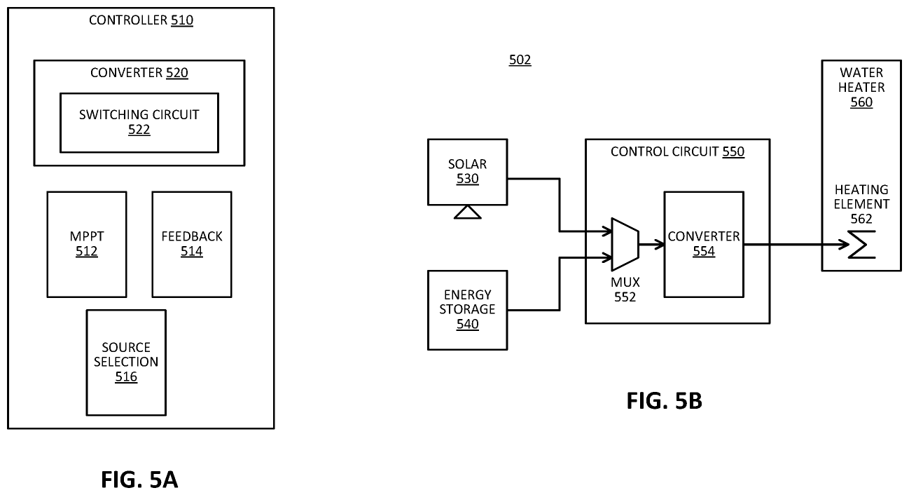

FIG. 5A is a block diagram of an example of a controller for a system that charges a heating element with a switched DC source. Controller 510 represents a controller in accordance with an example of system 100, or an example of system 300, or an example of system 400. Controller 510 can include a microcontroller, logic array, a control board, processor, or other component.

Controller 510 either includes or controls a power converter circuit that generates and transfers the energy from a DC energy source to a resistive load that changes impedance in response to a change in temperature. Converter 520 represents the power converter circuit. Converter 520 includes switching circuit 522 to switch DC power from the DC energy source to the resistive load. In one example, switching circuit 522 is controlled by control signals provided by controller 510. In one example, the signals that control switching circuit 522 can be considered to be provided by control circuitry separate from controller 510, and can be part of converter 520.

MPPT 512 represents a maximum power point tracking unit of controller 510. The operation of MPPT 512 enables controller 510 to track the maximum power point based on conditions of the PV source as well as based on changing impedance of the load due to temperature changes.

Feedback 514 represents control logic in controller 510 to enable the controller to receive feedback information to monitor changing conditions in the system. For example, and specifically for purposes of what is described herein, feedback 514 can enable controller 510 to receive and respond to temperature changes in the resistive load. In one example, controller 510 receives feedback 514 at least in part by monitoring a thermostat in a water heater. Based on changes in the temperature, controller 510 can adjust the switching of switching circuit 522 to provide better impedance matching between the power generated from the energy source and the resistive load.

Source selection 516 represents an ability for controller 510 to manage how power is directed in the system. In one example, source selection 516 enables controller 510 to select a solar energy source as the source to power either a resistive heating element or to charge an energy storage device. In one example, source selection 516 enables controller 510 to select between a solar energy source and an energy storage source to produce switched DC power to provide to the resistive load.

FIG. 5B is a block diagram of an example of a hybrid water heating system that selects between DC sources. System 502 represents a system in accordance with an example of system 100, or an example of system 300, or an example of system 400. System 502 alternatively represents the control in the system as control circuit 550. Alternatively, control circuit 550 can be referred to as “the electronics,” referring to the electronic control components that manage the operation of the system. Control circuit 550 can include a microcontroller, logic array, a control board, processor, or other component. In one example, control circuit 550 represents an example of controller 510.

Solar 530 represents a solar panel or multiple panels in parallel to provide PV energy for system 502. Energy storage 540 represents an energy storage device that can be charged up from energy from solar 530. In one example, control circuit 550 can include multiplexer (mux) 552 to select between solar 530 and energy storage 540.

Converter 554 represents converter hardware that enables control circuit 550 to convert energy from the selected source to generate a switch DC signal. Converter 554 provides the switch DC power to heating element 562 of water heater 560 in accordance with any example herein.

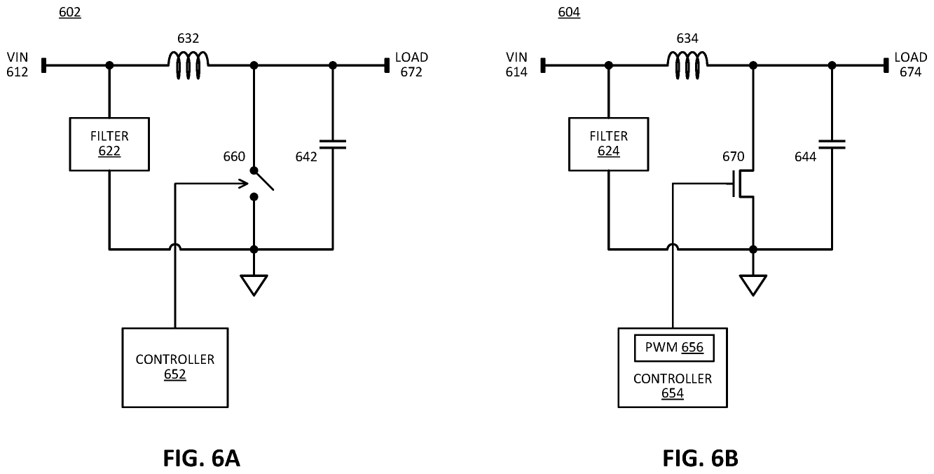

FIG. 6A is a circuit representation of an example of a system that switches a DC source with a switching device. System 602 represents converter hardware in accordance with any example herein.

System 602 includes a node to receive input voltage, VIN 612. VIN 612 can be filtered or conditioned with filter 622, which represents circuitry that can filter and shape the input signal. Inductor 632 represents a magnetic energy storage device that controls the input impedance of the signal. Capacitor 642 represents output energy storage to charge and hold the output voltage to form the switched output.

Switch 660 represents any type of switching circuitry to perform high-speed switching of the DC signal. The high-speed switching generates a high frequency signal with a frequency at least an order of magnitude higher than a typical grid AC power signal. In one example, system 602 provides a switched DC current.

Controller 652 represents control logic, such as provided by a controller device, to control the switching of switch 660. In one example, controller 652 controls the switching of switch 660 through a pulse width modulator (PWM) signal. System 602 provides the switched output signal to load 672, which can be a resistive load in accordance with any example herein.

FIG. 6A is a circuit representation of an example of a system that switches a DC source with a switching device. System 604 represents converter hardware in accordance with any example herein.

System 604 includes a node to receive input voltage, VIN 614. VIN 614 can be filtered or conditioned with filter 624, which represents circuitry that can filter and shape the input signal. Inductor 634 represents a magnetic energy storage device that controls the input impedance of the signal. Capacitor 644 represents output energy storage to charge and hold the output voltage to form the switched output.

Transistor 670 represents any type of transistor or transistor-based driver circuitry to perform high-speed switching of the DC signal. In one example, transistor 670 is a high power metal-oxide-semiconductor field effect transistor (MOSFET). In one example, system 604 includes multiple power MOSFETs in parallel to provide higher current capability to system 604. The high-speed switching with the transistors generates a high frequency signal with a frequency at least an order of magnitude higher than a typical grid AC power signal. In one example, system 604 provides a switched DC current.

Controller 654 represents control logic, such as provided by a controller device, to control the switching of transistor 670. In one example, controller 654 controls the switching of transistor 670 through a pulse width modulator (PWM) signal. PWM 656 represents a PWM generator in controller 654. System 604 provides the switched output signal to load 674, which can be a resistive load in accordance with any example herein.

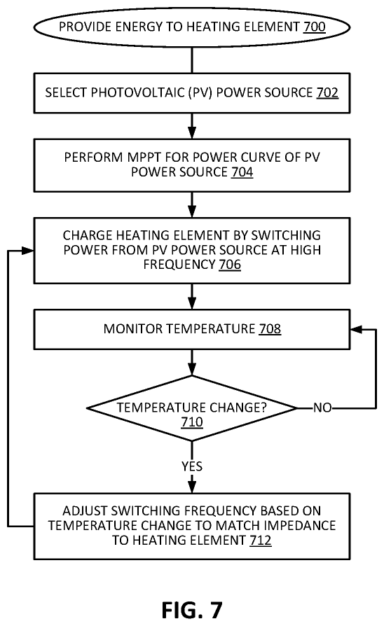

FIG. 7 is a flow diagram of an example of powering a heating element. Process 700 represents a process to provide energy to a heating element in accordance with any system described. In one example, the system controller selects a photovoltaic (PV) power source as the source for energy to charge the heating element, at 702.

In one example, the controller performs MPPT for the power curve (e.g., the V-I curve) of the PV power source, at 704. In one example, the MPPT tracks the maximum impedance matching point of the system, even when the resistive load changes impedance due to a temperature change. With a frequency selected based on the MPP found by MPPT, the system can charge the heating element by switching power from the PV power source at a high frequency, at 706.

The controller can monitor the temperature of the heating element, at 708. If there is no temperature change detected, at 710 NO branch, the controller can continue to monitor the temperature at 708. In one example, the temperature change refers to a change that is detectable by the system. For example, the temperature changes can be detected as threshold steps of temperature change.

If the controller detects a temperature change, at 710 YES branch, in one example, the controller adjusts a switching frequency based on the temperature change to match the impedance to the heating element, at 712. The controller can then cause the converter hardware to charge the heating element with the newly selected frequency of switched DC power, at 706. Thus, the controller can change the frequency of the switched DC power based on detection of a change in the operating environment or operating conditions of the heating element.

In general with reference to the descriptions herein, in one aspect, a controller apparatus includes: a resistive load that changes resistance based on temperature; and a converter circuit to power the resistive load from a direct current (DC) source, including a switching circuit to generate a pseudo-DC current to power the resistive load, with high-speed switching of current from the DC source.

In accordance with an example of the controller apparatus, the resistive load comprises a material that heats up in response to a high frequency signal and not to a constant voltage signal. In accordance with any preceding example of the controller apparatus, the resistive load comprises a water heater element. In accordance with any preceding example of the controller apparatus, in one example, the converter circuit is to generate a low-voltage pseudo-DC signal. In accordance with any preceding example of the controller apparatus, in one example, the controller apparatus includes: a maximum power point tracking (MPPT) system to detect a maximum power point of a voltage-current characteristic curve for a photovoltaic (PV) source; wherein the converter circuit is to power the resistive load with power from the PV source. In accordance with any preceding example of the controller apparatus, in one example, the converter circuit is to change switching based on detection of a temperature change in the resistive load to change an impedance match to the resistive load. In accordance with any preceding example of the controller apparatus, in one example, the change in the switching comprises a change in frequency of the switching circuit.

In general with reference to the descriptions herein, in one aspect, a water heater system includes: a water heater tank; a photovoltaic (PV) source; an electrical heating element that changes resistance based on temperature; and a control circuit including a maximum power point tracking (MPPT) unit to detect a maximum power point of the PV source and a switching circuit to generate a pseudo-DC current to power the resistive load, with high-speed switching of current from the DC source.

In accordance with an example of the water heater system, the control circuit is to change switching based on detection of a temperature change in the resistive load to change an impedance match to the resistive load. In accordance with any preceding example of the water heater system, in one example, the change in the switching comprises a change in frequency of the switching circuit. In accordance with any preceding example of the water heater system, in one example, the electrical heating element comprises a solar heating element and further comprising a second heating element. In accordance with any preceding example of the water heater system, in one example, the solar heating element is located near a bottom of the water heater tank and the second heating element is located near a top of the water heater tank. In accordance with any preceding example of the water heater system, in one example, the second heating element comprises an electrical grid heating element to be heated by electrical power from a grid system. In accordance with any preceding example of the water heater system, in one example, the second heating element comprises a gas heating element. In accordance with any preceding example of the water heater system, in one example, the water heater system includes: a thermostat to monitor water temperature inside the water heater tank, and provide the detection of the temperature change to the control circuit. In accordance with any preceding example of the water heater system, in one example, the water heater system includes: an energy storage device to store energy from the PV source, the control circuit to alternatively charge the electrical heating element from energy from the energy storage device. In accordance with any preceding example of the water heater system, in one example, the pseudo-DC signal comprises a low-voltage pseudo-DC signal. In accordance with any preceding example of the water heater system, in one example, the control circuit further comprises: a maximum power point tracking (MPPT) system to detect a maximum power point of a voltage-current characteristic curve for the PV source.

In general with reference to the descriptions herein, in one aspect, a method includes: detecting a maximum power point for a voltage-current characteristic curve for a photovoltaic (PV) source; detecting a change in temperature in an operating environment of an electrical heating element that changes resistance based on temperature; and charging the electrical heating element with power from the PV source, including adjusting switching of a switching circuit based on detection of the change in temperature to change an impedance match to the electrical heating element. In accordance with an example of the method, adjusting switching comprises changing the frequency of the switching circuit.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A controller apparatus, comprising:
a resistive load that changes resistance based on temperature; and
a converter circuit to power the resistive load from a direct current (DC) source, including a switching circuit to generate a pseudo-DC current to power the resistive load, with high-speed switching of current from the DC source.

2. The controller apparatus of claim 1, wherein the resistive load comprises a material that heats up in response to a high frequency signal and not to a constant voltage signal.

3. The controller apparatus of claim 1, wherein the resistive load comprises a water heater element.

4. The controller apparatus of claim 3, wherein the converter circuit is to generate a low-voltage pseudo-DC signal.

5. The controller apparatus of claim 1, further comprising:
a maximum power point tracking (MPPT) system to detect a maximum power point of a voltage-current characteristic curve for a photovoltaic (PV) source;
wherein the converter circuit is to power the resistive load with power from the PV source.

6. The controller apparatus of claim 1, wherein the converter circuit is to change switching based on detection of a temperature change in the resistive load to change an impedance match to the resistive load.

7. The controller apparatus of claim 6, wherein the change in the switching comprises a change in frequency of the switching circuit.

8. A water heater system, comprising:
a water heater tank;
a photovoltaic (PV) source;
an electrical heating element that changes resistance based on temperature; and
a control circuit including a maximum power point tracking (MPPT) unit to detect a maximum power point of the PV source and a switching circuit to generate a pseudo-DC current to power the resistive load, with high-speed switching of current from the PV source.

9. The water heater system of claim 8, wherein the control circuit is to change switching based on detection of a temperature change in the resistive load to change an impedance match to the resistive load.

10. The water heater system of claim 9, wherein the change in the switching comprises a change in frequency of the switching circuit.

11. The water heater system of claim 8, wherein the electrical heating element comprises a solar heating element and further comprising a second heating element.

12. The water heater system of claim 11, wherein the solar heating element is located near a bottom of the water heater tank and the second heating element is located near a top of the water heater tank.

13. The water heater system of claim 11, wherein the second heating element comprises an electrical grid heating element to be heated by electrical power from a grid system.

14. The water heater system of claim 11, wherein the second heating element comprises a gas heating element.

15. The water heater system of claim 8, further comprising:
a thermostat to monitor water temperature inside the water heater tank, and provide the detection of the temperature change to the control circuit.

16. The water heater system of claim 8, further comprising:
an energy storage device to store energy from the PV source, the control circuit to alternatively charge the electrical heating element from energy from the energy storage device.

17. The water heater system of claim 8, wherein the pseudo-DC signal comprises a low-voltage pseudo-DC signal.

18. The water heater system of claim 8, wherein the control circuit further comprises:
a maximum power point tracking (MPPT) system to detect a maximum power point of a voltage-current characteristic curve for the PV source.

19. A method for heating water, comprising:
detecting a maximum power point for a voltage-current characteristic curve for a photovoltaic (PV) source;
detecting a change in temperature in an operating environment of an electrical heating element that changes resistance based on temperature; and
charging the electrical heating element with power from the PV source, including adjusting switching of a switching circuit based on detection of the change in temperature to change an impedance match to the electrical heating element.

20. The method of claim 19, wherein adjusting switching comprises changing a frequency of the switching circuit.
